(19) United States
(12) Patent Application Publication
(10) Pub. No.: US 2015/0116331 A1
(43) Pub. Date: Apr. 30, 2015

(54) SYSTEM AND METHOD FOR DISPLAYING COMPETITIVE LAG-LEAD DATA

(71) Applicant: JAYBIRD LLC, Salt Lake City, UT (US)

(72) Inventor: Judd Armstrong, Parrearra (AU)

(73) Assignee: JAYBIRD LLC, Salt Lake City, UT (US)

(21) Appl. No.: 14/146,663

(22) Filed: Jan. 2, 2014

Related U.S. Application Data
(63) Continuation-in-part of application No. 14/137,734, filed on Dec. 20, 2013.
Application No. 14/137,734 is a continuation-in-part of application No. 14/062,815, filed on Oct. 24, 2013.

(51) Int. Cl. G06T 11/20

(52) U.S. Cl. CPC G06T 11/206
USPC 345/440

(57) ABSTRACT

A system and method for displaying competitive lag-lead data includes a plurality of display pixels oriented on a wearable activity monitoring device configured to display a visual representation of a user's activity score, or other metrics of interest, as compared with the activity score, or other metrics of interest, of one or more reference activity monitoring devices.

### CROSS-REFERENCE TO RELATED APPLICATIONS

This application is a continuation-in-part of and claims the benefit of U.S. patent application Ser. No. 14/137,734, filed Dec. 20, 2013, titled “System and Method for Providing a Smart Activity Score,” which is a continuation-in-part of U.S. patent application Ser. No. 14/062,815, filed Oct. 24, 2013, titled “Wristband with Removable Activity Monitoring Device.” The contents of Ser. Nos. 14/137,734 and 14/062,815 are incorporated herein by reference.

### TECHNICAL FIELD

The present disclosure relates generally to fitness monitoring devices, and more particularly to a system and method for displaying competitive lag-lead data.

### BACKGROUND

Previous generation movement monitoring and fitness tracking devices generally enabled only a tracking of activity that accounts for total calories burned based on universal metabolic equivalent tasks. Currently available fitness tracking devices now add functionality that customizes metabolic equivalent tasks according to user characteristics. One issue with currently available fitness tracking devices is that they do not account for the performance state of the user in a scientific, user-specific way, or allow for easy comparison of metrics with other users in real time. Another issue is that currently available solutions do not account in a precise manner for the health and performance benefits of sustained activity.

### BRIEF SUMMARY OF THE DISCLOSURE

In view of the above drawbacks, there exists a long-felt need for fitness monitoring devices that detect a fatigue level in a scientific way and provide user-specific performance feedback and activity tracking based on the fatigue level. Further, there is a need for fitness monitoring devices that provide increased resolution into the performance benefits of sustained activity.

The present disclosure is directed towards activity monitoring devices. In particular, embodiments of the present invention are directed towards a competitive lag-lead display for comparing metrics of interest tracked by multiple activity monitoring devices.

One embodiment of the disclosure provides a first activity monitoring device for capturing a first metric of interest, receiving a second metric of interest from a second activity monitoring device, the second metric of interest being of the same type as the first metric of interest, and visually displaying on a competitive lag-lead display a comparison of the first and second metrics of interest.

The activity monitoring device may be a wearable activity monitoring device. In many embodiments, the activity monitoring device also comprises the competitive lag-lead display. For example, the competitive lag-lead display may incorporate a plurality of display pixels on a protruding top side of the activity monitoring device. The display pixels may be light emitting diodes. Further, to maintain a narrow profile for the activity monitoring device, the display pixels may be oriented in a straight line. In one embodiment, there are twelve display pixels. Each display pixel may display two or more colors, wherein at least one color may represent the first metric of interest, and the second color may represent the second metric of interest, such that the lag-lead display may depict a comparison between the first and the second metrics of interest by simultaneously illuminating a number of display pixels representing a value for the first metric of interest in the first color and a number of display pixels representing a value for the second metric of interest in the second color. For example, the metrics of interest may be activity scores, smart activity scores, distance traveled, recovery scores, calories burned, or other metrics measured by the activity monitoring device.

The activity monitoring device includes a movement monitoring module that monitors a movement to determine a metabolic loading associated with the movement, a metabolic activity score module that creates and updates a metabolic activity score based on the metabolic loading and the movement, a fatigue level module that detects a fatigue level, and a smart activity score module that creates and updates a smart activity score by modifying, based on the fatigue level, the metabolic activity score.

A method for providing a smart activity score may include monitoring a movement to determine a metabolic loading associated with the movement, creating and updating a metabolic activity score based on the metabolic loading and the movement, detecting a fatigue level, and creating and updating a smart activity score by modifying the metabolic activity score. The metabolic loading may be determined from a set of metabolic loadings, each metabolic loading being determined according to user information from a user. Some embodiments use a wearable sensor to accomplish at least one of the steps of monitoring the movement, creating and updating the metabolic activity score, detecting the fatigue level, and creating and updating the smart activity score.

The smart activity score can be associated with a measuring period. In such embodiments, the smart activity score module calculates an average smart activity score from a set of past smart activity scores. Each past smart activity score is associated with a past measuring period. The user information includes a user lifestyle selected from a set of reference lifestyles.

One exemplary system for a competitive lag-lead display includes a processor and at least one computer program residing on the processor. The computer program is stored on a non-transitory computer readable medium having computer executable program code embodied thereon. The computer executable program code is configured to monitor movement and sensor readings from the activity monitoring device, calculate metrics of interest such as activity scores, smart activity scores, distance traveled, and calories burned, compare a first metric of interest with a second metric of interest from a second activity monitoring device, and to cause the results of the comparison to be displayed on a lag-lead display. In other exemplary embodiments, the lag-lead display may also display time using a first color display pixel to represent hours and a second color display pixel to represent minutes.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a cross-sectional view of the wristband and electronic modules of an example activity monitoring device.

FIG. 2 illustrates a perspective view of an example activity monitoring device.

FIG. 3 illustrates a cross-sectional view of an example assembled activity monitoring device.

FIG. 4 illustrates a side view of an example electronic capsule.

FIG. 5 illustrates a cross-sectional view of an example electronic capsule.

FIG. 6 illustrates perspective views of wristbands as used in one embodiment of the disclosed activity monitoring device.

FIG. 7 illustrates a competitive lag-lead display system.

FIG. 8A is a flow diagram illustrating an exemplary method for comparing and displaying metrics of interest on a competitive lag-lead display.

FIG. 8B is an exemplary table of relative relationships between metric of interest ranges and lag-lead values for display on a competitive lag-lead display.

FIG. 9 illustrates a system for communicating metrics of interest between two or more activity monitoring devices.

FIG. 10A is an operational flow diagram illustrating an exemplary method for creating and updating a smart activity score.

FIG. 10B is an exemplary metabolic loading table.

FIG. 10C is an exemplary activity intensity library.

FIG. 11 illustrates an example computing module that may be used to implement various features of the systems and methods disclosed herein.

The figures are not intended to be exhaustive or to limit the disclosure to the precise form disclosed. It should be understood that the disclosure can be practiced with modification and alteration, and that the disclosure can be limited only by the claims and the equivalents thereof.

### DETAILED DESCRIPTION

Embodiments of the present disclosure are directed toward systems and methods for displaying competitive lag-lead values corresponding to metrics of interest tracked by two or more activity monitoring devices.

According to some embodiments of the disclosure, a competitive lag-lead display depicts comparisons of a first metric of interest from a first activity monitoring device with a second metric of interest from a second activity monitoring device. For example, two users may compete over accomplishing particular goals, such as maintaining a higher smart activity score than the other user. In this case, each user's activity monitoring device may be configured to display that user's own smart activity score relative to the other user's smart activity score using a plurality of multi-color display pixels on a top surface of the activity monitoring device. In several embodiments, the activity monitoring device is wearable by fitting the device into a wristband, sock, shoe, or other accessory or article of clothing.

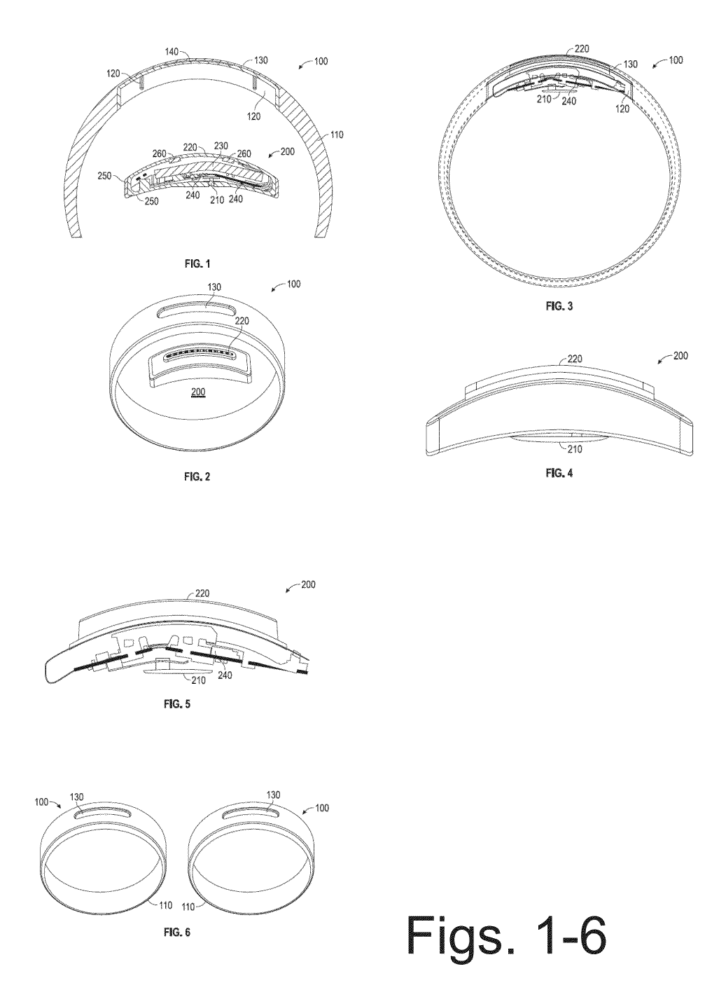

FIG. 1 is a diagram illustrating a cross-sectional view of an exemplary embodiment of an activity monitoring device. Referring now to FIG. 1, an activity monitoring device comprises an electronic capsule 200 and a wristband 100. The electronic capsule 200 comprises a wrist biosensor 210, a finger biosensor 220, a battery 230, one or more logic circuits 240, and a casing 250.

In some embodiments, the one or more logic circuits 240 comprise an accelerometer, a wireless transmitter, and circuitry. The logic circuits may further comprise a gyroscope. These logic circuits may be configured to process electronic input signals from the biosensors and the accelerometer, store the processed signals as data, and output the data using the wireless transmitter. The transmitter is configured to communicate using available wireless communications standards. For example, in some embodiments, the wireless transmitter may be a Bluetooth® transmitter, a Wi-Fi transmitter, a GPS transmitter, a cellular transmitter, or some combination thereof. In an alternative embodiment, the wireless transmitter may further comprise a wired interface (e.g. USB, fiber optic, HDMI, etc.) for communicating stored data.

The logic circuits 240 may be electrically coupled to the wrist biosensor 210 and the finger biosensor 220. In addition, the logic circuits are configured to receive and process a plurality of electric signals from each of the wrist biosensor 210 and finger biosensor 220. In some embodiments, the plurality of electric signals comprise an activation time signal and a recovery time signal such that the logic circuits 240 may process the plurality of signals to calculate an activation recovery interval equal to the difference between the activation time signal and the recovery time signal. In some embodiments, the plurality of signals may comprise electro-cardio signals from a heart, and the logic circuits may process the electro-cardio signals to calculate and store a RR-interval, and the RR-interval may be used to calculate and store a heart rate variability (HRV) value. Here, the RR-interval is equal to the delta in time between two R-waves, where the R-waves are the electro-cardio signals generated by a ventricle contraction in the heart.

In some embodiments, the logic circuits may further detect and store metrics such as the amount of physical activity, sleep, or rest over a recent time period, or the amount of time without physical activity over a recent period of time. The logic circuits may then use the HRV, or the HRV in combination with said metrics, to calculate a recovery score. For example, the logic circuits may detect the amount of physical activity and the amount of sleep a user experienced over the last 48 hours, combine those metrics with the user's HRV, and calculate a recovery score of between 1 and 10, wherein the recovery score could indicate the user's physical condition and aptitude for further physical activity that day. The recovery score may also be calculated on a scale of between 1 and 100, or any other scale or range.

Wristband 100 comprises a material 110 configured to encircle a human wrist. In one embodiment, wristband 100 is adjustable. A cavity 120 is notched on the radially inward facing side of the wristband and shaped to substantially the same dimensions as the profile of the electronic capsule. In addition, an aperture 130 is located in the material 110 within cavity 120. The aperture 130 is shaped to substantially the same dimensions as the profile of the finger biosensor 220. The cavity and aperture combination is designed to detachably couple to the electric capsule 200 such that, when the electric capsule 200 is positioned inside cavity 120, the finger biosensor 220 protrudes through the aperture 130. Electronic capsule 200 may further comprise one or more magnets 260 configured to secure capsule 200 to cavity 120. Magnets 260 may be concealed in casing 250. Alternatively, cavity 120 may be configured to conceal magnets 260 when electric capsule 200 detachably couples to the cavity and aperture combination.

Wristband 100 may further comprise a steel strip 140 concealed in material 110 within cavity 120. In this embodiment, when the electronic capsule 200 is positioned within the cavity 120, the one or more magnets 260 are attracted to the steel strip 140 and pull electronic capsule 200 radially outward with respect to the wristband. The force provided by magnets 260 may detachably secure electronic capsule 200 inside cavity 120. In alternative embodiments, the electronic capsule may be positioned inside the wristband cavity and affixed using a form-fit, press-fit, snap-fit, friction-fit, VELCRO, or other temporary adhesion or attachment technology.

FIG. 2 illustrates a perspective view of one embodiment of the disclosed activity monitoring device, in which wristband 100 and electronic capsule 200 are unassembled. FIG. 3 illustrates a cross-sectional view of one embodiment of a fully assembled wristband with removable athletic monitoring device. FIG. 4 illustrates a side view of an electronic capsule 200 according to one embodiment of the disclosure. FIG. 5 illustrates a cross-sectional view of electronic capsule 200. FIG. 6 is a perspective view of two possible variants of the wristband according to some embodiments of the disclosure. Wristbands may be constructed with different dimensions, including different diameters, widths, and thicknesses, in order to accommodate different human wrist sizes and different preferences.

In some embodiments of the disclosure, the electronic capsule may be detachably coupled to a cavity on a shoe and/or a sock. In other embodiments, the electronic capsule may be detachably coupled to sports equipment. For example, the electronic capsule may be detachably coupled to a skateboard, a bicycle, a helmet, a surfboard, a paddle boat, a body board, a hang glider, or other piece of sports equipment. In these embodiments, the electronic capsule may be affixed to the sports equipment using magnets. Alternatively, in other embodiments, the electronic capsule can be affixed using a form-fit, snap-fit, press-fit, friction-fit suction cup, VELCRO, or other technology that would be apparent to one of ordinary skill in the art.

In one embodiment of the disclosure, the electronic capsule may further comprise an optical sensor such as a heart rate sensor or oximeter. In this embodiment, the optical sensor may be positioned to face radially inward towards a human wrist when the wristband is fit on the human wrist. Alternatively, the optical sensor may be separate from the electronic capsule, but still detachably coupled to the wristband and electronically coupled to the circuit boards enclosed in the electronic capsule. Wristband 100 and electronic capsule 200 may operate in conjunction with a system for providing a smart activity score.

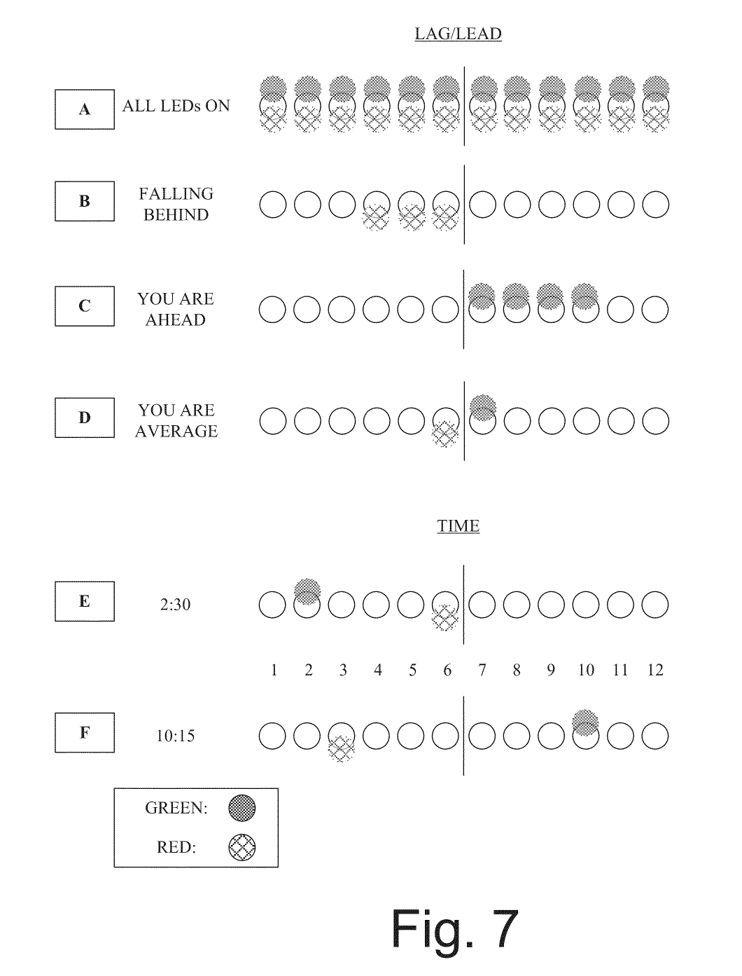

FIG. 7 is an illustration of a competitive lag-lead display. Referring now to FIG. 7, a competitive lag-lead display may include a plurality of display pixels. In one example, the display includes twelve display pixels. Each display pixel may be a light emitting diode (LED) configured on an electronic capsule from a wearable activity monitor apparatus—for example, the apparatus shown in FIGS. 1 through 6. Referring again to FIG. 2, electronic capsule 200 includes biosensor 220. Biosensor 220 may also include a plurality of display pixels. For example, there may be twelve display pixels configured in a straight line to maintain a slim profile for the electronic capsule. Further, each display pixel may comprise more than one LED to display different colors at the same pixel. In one example, each display pixel may display both green and red LEDs.

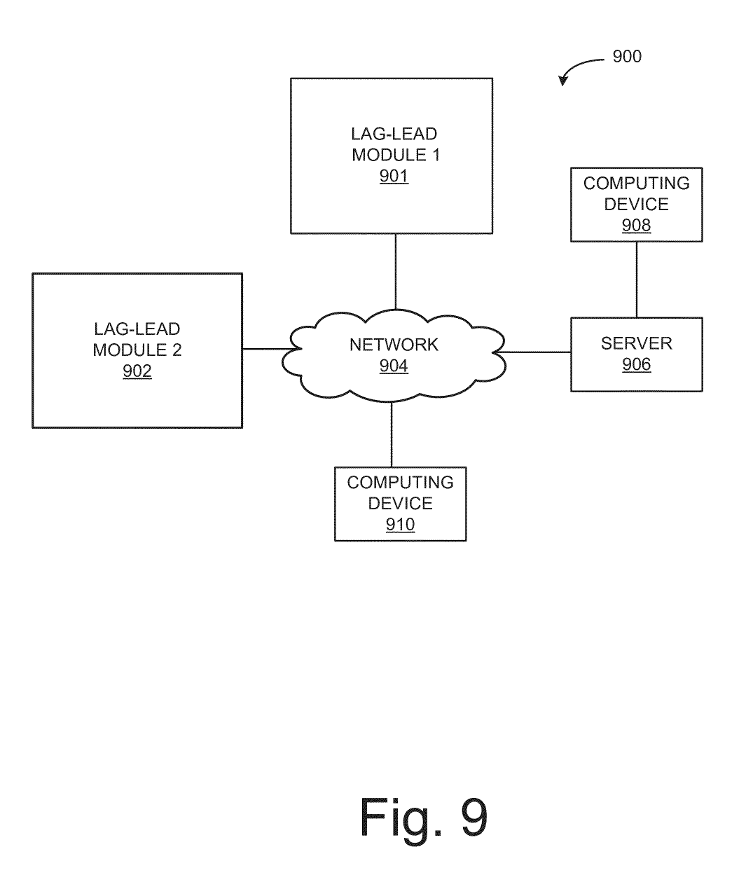

Referring again to FIG. 7A, twelve display pixels are shown wherein each display pixel may be either green or red. This competitive display system may be designed to interface with the smart activity score comparison between a first user utilizing a first activity monitoring system and a second user utilizing a second activity monitoring system, as described above and illustrated in flow diagram shown in FIG. 7A. The devices may communicate with a server and with each other utilizing the mechanism illustrated in FIG. 9.

The competitive display system on the first activity monitoring device may illustrate when the first user's smart activity score is either less than or more than the second user's smart activity score as measured and tracked by the second activity monitoring device. For example, FIG. 7B illustrates a scenario where the first user's smart activity score is less than, or lagging behind the second user's smart activity score—three LED's out of the six possible LEDs to the left of a center line show that the first user's smart activity score is moderately behind the second user's smart activity score. The first user's score may fall even further behind the second user's score, in which case more red LED's to the left of the center line of the display would light up.

The lag-lead competitive display may also display the scenario wherein the first user's smart activity score exceeds the second user's smart activity score. FIG. 7C displays this scenario where the first user's score more than moderately exceeds the second user's score, as depicted by four of six green LEDs to the right of the center line being illuminated. The first user's smart activity score may exceed the second user's smart activity score by an even greater amount, such that all six green LEDs to the right of the center line may be illuminated.

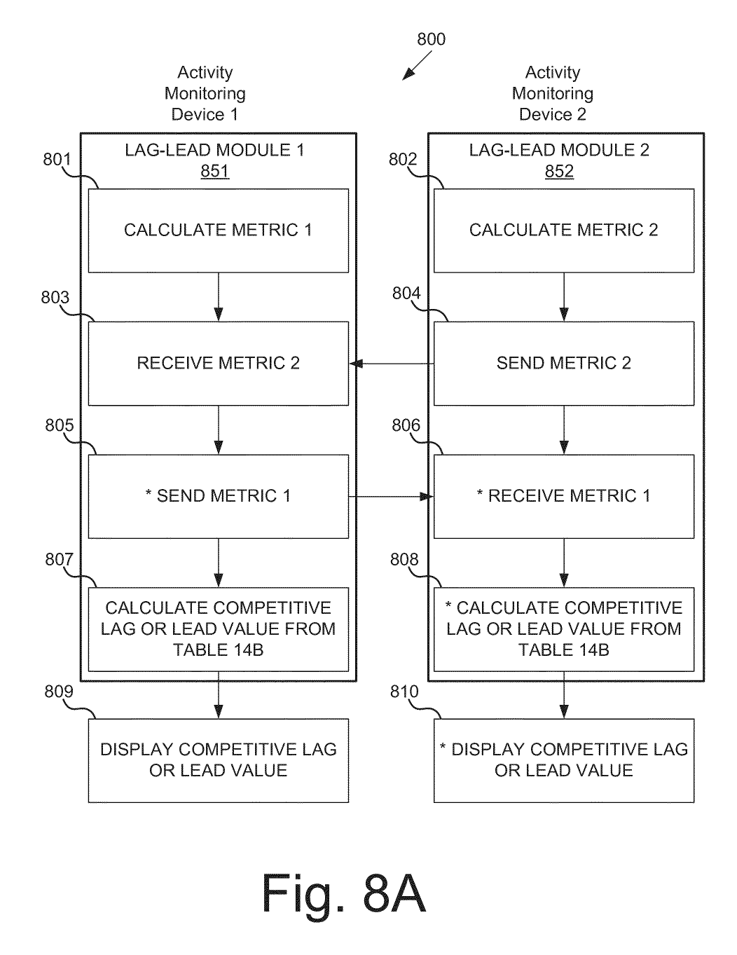

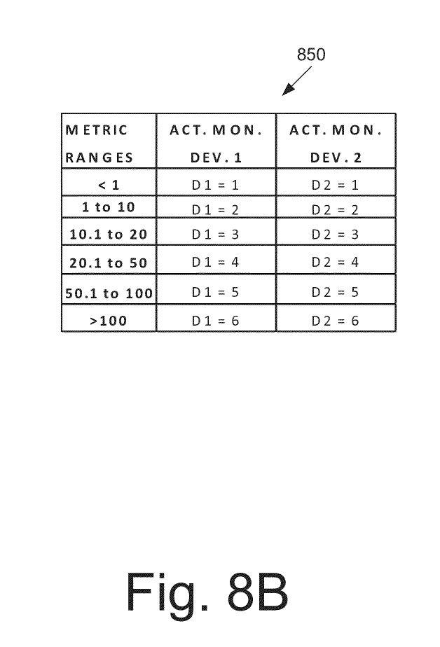

The lag-lead competitive display may also display the scenario wherein the first smart activity score is approximately equal to the second smart activity score. FIG. 7D shows a situation where these two scores are approximately equal, as depicted by one red LED being illuminated to the left of the center line and one green LED being illuminated to the right of the center line. Other combinations of illuminated red and green LEDs are possible to display different types of information, and the example illustrated in FIG. 8 is not meant to limit these uses.

The lag-lead competitive display may also be used to compare other metrics between two activity monitoring systems. For example, the competitive display may compare activity scores, fatigue levels, number of calories burned, recovery scores, total distance traveled, or other metrics that may be monitored and tracked by the activity monitoring device, as disclosed herein, or that would be understood to one of ordinary skill in the art.

Referring now to FIGS. 7E and 7F, the lag-lead competitive display may also display time of day. A time calculation and display module may be used to calculate the display format for the time of day and cause the time of day to display on the lag-lead display. For example, the display may be configured such that each of the twelve display pixels may represent one hour, or alternatively, one five minute notch as would be depicted on a watch face. The first pixel from the left may represent one hour and five minutes, and the last pixel from the right may represent twelve hours and fifty-five minutes. Further, an illuminated green LED may represent hours and an illuminated red LED may represent minutes. This example is arbitrary, and other colors may be used to represent either hours or minutes, and other configurations of the display pixels may be used. According to the example depicted in FIG. 7E, the time 2:30 is represented by illuminating the second pixel from the left with a green LED to represent hour two, and illuminating the sixth pixel from the left with a red LED, representing thirty minutes. Alternatively, in FIG. 7F, the time 10:15 is depicted by illuminating the tenth pixel from the left with a green LED to represent ten hours, and illuminating the third pixel from the right with a red LED to represent fifteen minutes.

FIG. 8A is a flow diagram of an exemplary method for displaying a competitive lag-lead value. Referring now to FIG. 8A, a first metric of interest 801 is calculated by a lag-lead module 851 on a first activity monitoring device and a second metric of interest 802 is calculated by lag-lead module 852 on a second activity monitoring device. The first and second metric of interest may be the same type of metric. For example, both metrics of interest may be smart activity scores, where a first smart activity score is from a first user and a second smart activity score is from a second user. In step 804, lag-lead module 852 may send the second metric of interest to the first activity monitoring device, or alternatively, the second metric of interest may be sent to a server as an intermediate step. Lag-lead module 851 on the first activity monitoring device may receive the second metric of interest in step 803 and calculate a relative competitive lag-lead value from table 8B for both the first metric of interest and the second metric of interest. The competitive lag-lead value may be an array consisting of multiple competitive lag-lead value elements, wherein each element represents a metric of interest and corresponds to a display element color. For example, as depicted by Equation 1, the lag-lead value array may consist of a first lag-lead value element L(X₁), relating to a first user's activity, and a second lag-lead value element L(X₂), relating to a second user's activity, wherein L(X₁), corresponds to a first metric of interest MOI₁, a first display pixel position P₁, and a first display pixel color C₁, and L(X₂), corresponds to a second metric of interest MOI₂, a second display pixel position P₂, and a second display pixel color C₂.

$$[ \begin{matrix}L ( {X}_{1} ) \\ L ( {X}_{2} )\end{matrix} ] = [ \begin{matrix}{MOI}_{1} & ( {P}_{1} , {C}_{1} ) \\ {MOI}_{2} & ( {P}_{2} , {C}_{2} )\end{matrix} ] \qquad ( 1 )$$

Alternatively, the competitive lag-lead value may be a matrix representing multiple compared metrics of interest and multiple metric of interest types as illustrated by Equation 2.

$$[ \begin{matrix}L ( {X}_{1} ) \\ L ( {X}_{2} ) \\ ⋮ \\ L ( {X}_{i} )\end{matrix} ] = [ \begin{matrix}{MOI}_{11} & ⋯ & {MOI}_{1 j} & ( {P}_{11} , {C}_{11} ) & ⋯ & ( {P}_{1 j} , {C}_{1 j} ) \\ {MOI}_{21} & ⋱ & {MOI}_{2 j} & ( {P}_{21} , {C}_{21} ) & ⋱ & ( {P}_{2 k} , {C}_{2 j} ) \\ ⋮ & & ⋮ & ⋮ & & ⋮ \\ {MOI}_{i 1} & ⋯ & {MOI}_{ij} & ( {P}_{i 1} , {C}_{i 1} ) & ⋯ & ( {P}_{i j} , {C}_{i j} )\end{matrix} ] \qquad ( 2 )$$

In some embodiments, the competitive lag-lead value is a comparison of the first metric of interest with an average over time of the second metric of interest. In other embodiments, the competitive lag-lead value compares an average over time of the first metric of interest with an average over time of the second metric of interest. In step 809, the lag-lead module 851 causes lag-lead display 861 to display the competitive lag-lead values as previously described with respect to FIG. 7.

Still referring to FIG. 8A, in another embodiment, the communication and display of lag-lead values is bidirectional. In other words, the second activity monitoring device may display the comparison of the second metric of interest in reference to the first metric of interest, whereas the first activity monitoring device may display the comparison of the first metric of interest in reference to the second metric of interest, as depicted by optional steps 805, 806, 808, and 810. In other embodiments, more than two activity monitoring devices may be incorporated in the system. For example, the lag-lead display may compare three or more metrics of interest by incorporating three or more color options for the display pixels.

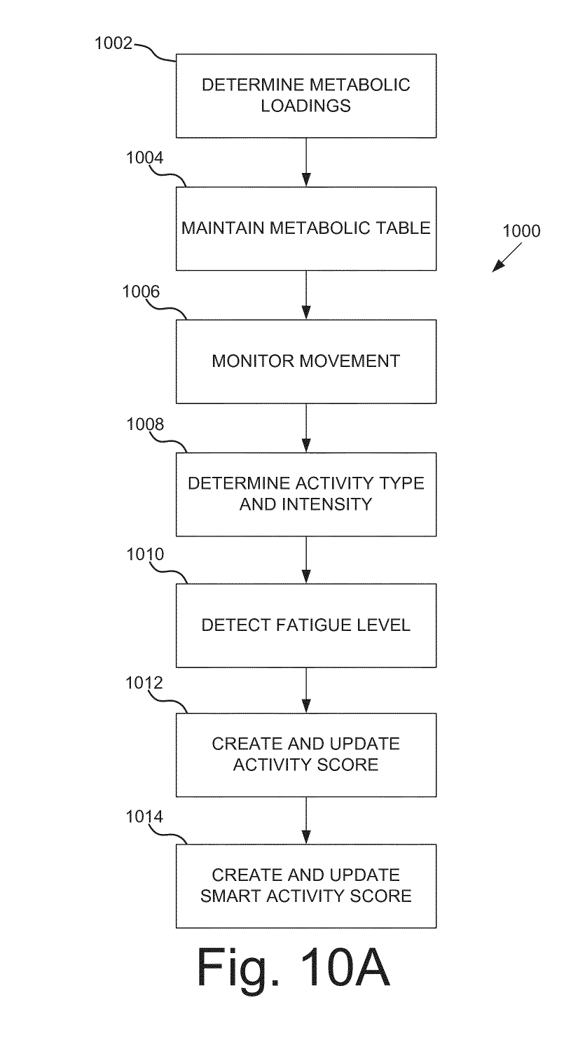

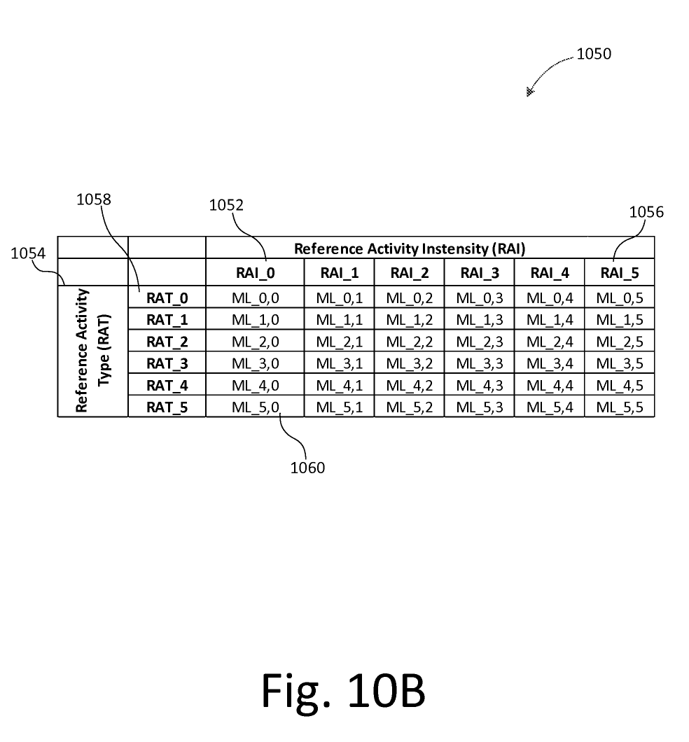

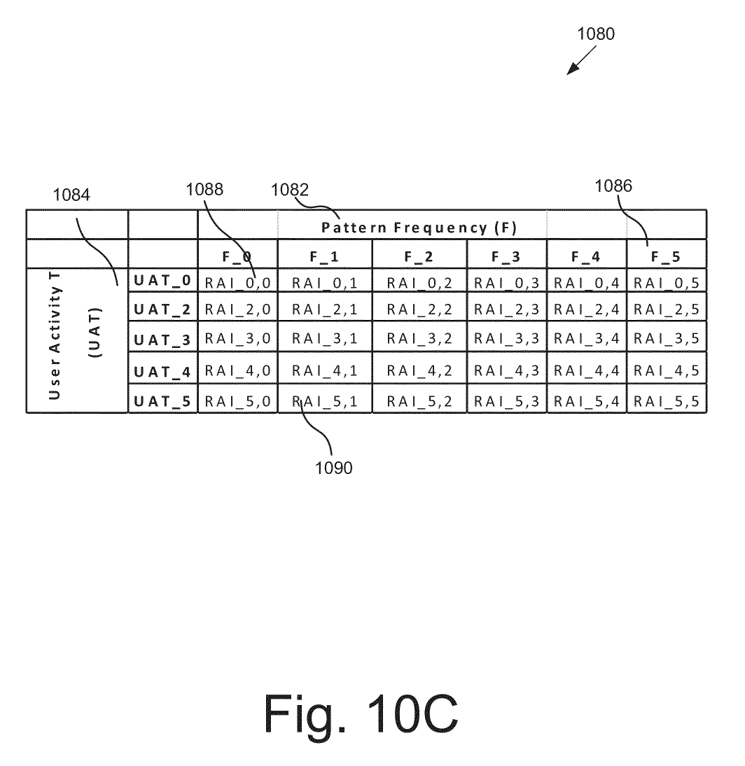

In any exemplary embodiments where metrics of interest are sent or received by an activity monitoring device, standard data transmission and communications mechanisms may be used. For example, communications mechanisms illustrated in FIG. 10 may be used to send metrics of interest data between activity monitoring devices. Such metrics of interest, as discussed, may include activity scores, smart activity scores, calories burned, distance traveled, fatigue levels, recovery scores, pulse rates, HRV values, or any other metrics capable of being monitored and measured by an activity monitoring device.

FIG. 8B is an exemplary reference table for converting metrics of interest into relative lag-lead values for display on a competitive lag-lead display. Table 8B is meant for exemplary purposes only and will vary depending on the type of metric compared and the value limits for that metric. Accordingly, different reference tables may exist for different metrics of interest. In general, Table 8B may be a lookup table such that the lag-lead system may determine how many display pixels should be illuminated for various metric values. For example, a smart activity score of 10 may relate to one display pixel being illuminated and a smart activity score of 100 or more may relate to six display pixels being illuminated. Other relationships are possible and would be known to one of ordinary skill in the art.

FIG. 9 is a schematic block diagram illustrating one embodiment of a system for communicating metrics of interest between two or more activity monitoring devices. System 900 includes multiple devices for calculating activity scores. For example, activity monitoring devices 901 and 902 may connect to network 904 via communications mechanisms 951 and 952. The communications mechanisms may include various known technologies, including WAN, LAN, Wi-FI, TCP/IP, Bluetooth®, 4G LTE, or other known communications standards. The system for communicating metrics of interest may also include server 1006 and computing devices 1008 and 1010.

Communication network 904 may be implemented in a variety of forms. For example, communication network 904 may be an Internet connection, such as a local area network (“LAN”), a wide area network (“WAN”), a fiber optic network, internet over power lines, a hard-wired connection (e.g., a bus), and the like, or any other kind of network connection. Communication network 904 may be implemented using any combination of routers, cables, modems, switches, fiber optics, wires, radio, and the like and using various wireless standards, such as Bluetooth®, Wi-FI, or 4G LTE such as to be compatible with communications mechanisms 951 and 952. One of skill in the art will recognize other ways to implement communication network 904.

Server 906 may direct communications made over communications network 904. Server 906 may be, for example, an Internet server, a router, a desktop or laptop computer, a smartphone, a tablet, a processor, a module, or the like. In one embodiment, server 906 directs communications between communications network 904 and computing devices 908 and/or 910. For example, server 906 may update information stored on computing device 908, or server 906 may send information to computing device 908 in real time.

Computing device 908 may take a variety of forms, such as a desktop or laptop computer, a smartphone, a tablet, a processor, or a module. In addition, computing device 908 may be a processor or module embedded in a wearable sensor, a bracelet, a smart-watch, a piece of clothing, an accessory, and so on. For example, computing device 908 may be substantially similar to devices embedded in electronic capsule 200, which may be embedded in and removable from wristband 100, as illustrated in FIG. 1. Computing device 908 may communicate with other devices over communication medium 904 with or without the use of server 906. In one embodiment, computing device 908 includes activity monitoring device 902.

FIG. 10A is an operational flow diagram illustrating an exemplary method 1000 for creating and updating a smart activity score in accordance with an embodiment of the present disclosure. For example, a smart activity score is one possible metrics of interest for comparison and display by the competitive lag-lead display system. A smart activity score may be calculated and updated, for example, by the operations of method 1000. The operations of method 1000 take into account a fatigue level of the user to create a smart activity score that accurately reflects the user's physical condition and performance capabilities.

Now referring to FIG. 10A, at step 1002, method 1000 monitors the movement of the user to determine a metabolic loading associated with the movement. In one embodiment, metabolic loadings are determined by identifying a user activity type from a set of reference activity types and by identifying a user activity intensity from a set of reference activity intensities. For example, method 1000 may determine a set of metabolic loadings according to information provided by a user (or user information). User information may include, for example, an individual's height, weight, age, gender, and geographic and environmental conditions. The user may provide the user information through a user interface of computing device 908 or of electronic capsule 200. Method 1000 may also determine the user information based on various measurements. For example, method 1000 may determine a user's body fat content or body type.

In various embodiments, a device (e.g., computing device 908) or a module (e.g., electronic capsule 200 or a module therein) stores or provides the metabolic loadings. The metabolic loadings may be maintained or provided by server 906 or over communication medium 904. In various embodiments, a movement monitoring module may monitor movement in step 1006 and determine activity type and intensity in step 1008 by comparing the movement to predetermined movement patterns for reference activity types. The movement may be tracked using sensors of the activity monitoring device such as accelerometers, altimeters, gyroscopes, wireless signal triangulation sensors, Global Positioning Satellite (GPS) sensors, or other movement monitoring sensors as would be known in the art. The reference activity types may include typical activities, such as running, walking, sleeping, swimming, bicycling, skiing, surfing, resting, working, and so on. The reference activity types may also include a catch-all category, for example, general exercise. The reference activity types may also include atypical activities, such as skydiving, SCUBA diving, and gymnastics. The typical reference activities may be provided, for example, by metabolic table 1050 in FIG. 10B.

Referring now to FIG. 10B, metabolic table 1050 may include metabolic loadings, such as metabolic loading 1060. Each metabolic loading 1060 corresponds to a reference activity type 1058 of the reference activity types 1054 and a reference activity intensity 1056 of the reference activity intensities 1052. Each metabolic loading 1060 may be identified by a unique combination of reference activity type 1054 and reference activity intensity 1052. For example, in the column and row arrangement discussed above, one of the reference activity types 1054 of a series of rows 1058 of reference activity types, and one of the reference activity intensities 1052 of a series of columns 1056 of reference activity intensities may correspond to a particular metabolic loading 1060. In such an arrangement, each metabolic loading 1060 may be identifiable by only one combination of reference activity type 1058 and reference activity intensity 1056.

In some examples of the disclosure, at step 1002, method 1000 determines the user activity intensity from a set of reference activity intensities. Method 1000 may determine the user activity intensity in a variety of ways. In one embodiment, method 1000 may associate the repetition period (or pattern frequency) and user activity type (UAT) with a reference activity intensity library to determine the user activity intensity that corresponds to a reference activity intensity. FIG. 10C illustrates one embodiment whereby this aspect of step 1002 may be accomplished, including reference activity intensity library 1080. Reference activity intensity library 1080 is organized by rows 1088 of reference activity types 1084 and columns 1086 of pattern frequencies 1082. In FIG. 10C, reference activity library 1080 is implemented in a table. Reference activity library 1080 may, however, be implemented other ways.

Referring again to FIG. 10A, step 1004 comprises creating and updating a metabolic activity score based on the metabolic loading and the movement. In one embodiment, method 1000 determines a duration of the activity type at a particular activity intensity (e.g., in seconds, minutes, or hours). Method 1000 may create and update the metabolic activity score by multiplying the metabolic loading by the duration of the user activity type at a particular user activity intensity. If the user activity intensity changes, method 1000 may multiply the new metabolic loading (associated with the new user activity intensity) by the duration of the user activity type at the new user activity intensity. Accordingly, in one embodiment, the activity score may be represented as a numerical value. By way of example, method 1000 may update the metabolic activity score by continually supplementing the metabolic activity score as new activities are undertaken by the user. Accordingly, the metabolic activity score may continually increase as the user participates in more and more activities.

In one embodiment, at step 1004, method 1000 creates and updates the metabolic activity score based on score periods. In one embodiment, at step 1002, monitoring the movement includes determining, during a score period, the metabolic loading associated with the movement. Score periods may include segments of time. For example, a score period may be ten seconds. In one embodiment, method 1000 monitors the user's movement to determine a user activity type, a user activity intensity, and a corresponding metabolic loading during each score period. Method 1000 may then calculate the metabolic activity score for that score period. As the movement changes over time, the varying characteristics of the movement are captures by the score periods.

In one embodiment, step 1004 includes creating and updating a set of periodic activity scores. Each period activity is based on the movement monitored during a set of score periods, and each period activity score is associated with a particular score period of the set of score periods. In one embodiment, the metabolic activity score is created and updated as an aggregate of period activity scores. The metabolic activity score may represent a running sum total of the period activity scores.

In another instance of the disclosure, step 1004 includes applying a score period multiplier to the score period to create an adjusted period activity score. In such an embodiment, the metabolic activity score is an aggregation of adjusted period activity scores. For example, method 1000 may introduce score period multipliers associated with certain score periods, such that the certain score periods contribute more or less to the metabolic activity score than other score periods during which the same movement is monitored. For example, if the user is performing a sustained activity, method 1000 may apply a score period multiplier to the score periods that occur during the sustained activity. By contrast, method 1000 may not apply a multiplier to score periods that are part of intermittent, rather than sustained, activity. As a result of the score period multiplier, the user's sustained activity may contribute more to the metabolic activity score than the user's intermittent activity. The score period multiplier may allow method 1000 to account for the increased demand of sustained, continuous activity relative to intermittent activity.

In some embodiments, step 1004 entails decreasing the metabolic activity score when the user consumes calories. For example, if the user goes running and generates an activity score of 1,000 as a result, but then the user consumes calories, method 1000 may decrease the activity score by 200 points, or any number of points. The decrease in the number of points may be proportional to the number of calories consumed. In other embodiments, method 1000 obtains information about specific aspects of the user's diet, and may award metabolic activity score points for healthy eating (e.g., fiber) and subtract points for unhealthy eating (e.g., excessive fat consumption).

Referring again to FIG. 10A, step 1006 involves detecting a fatigue level. In one embodiment, the fatigue level is the fatigue level of the user. Method 1000 may detect the fatigue level in various ways. For example, method 1000 detects the fatigue level by measuring a heart rate variability (HRV) of a user using logic circuits 240 (discussed above in reference in to FIG. 1). For example, when the HRV is more consistent (i.e., steady, consistent amount of time between heartbeats), the fatigue level may be lower. In other words, the body is more fresh and well-rested. When HRV is more sporadic (i.e., amount of time between heartbeats varies largely), the fatigue level may be higher.

Step 1006 of method 1000 may measure HRV. For example, in one embodiment, the method 1000 measures HRV using the combination of wrist biosensor 210 and finger biosensor 220. Information about the electrical potential provides cardiac information (e.g., HRV, fatigue level, heart rate information, and so on) and such information is processed at step 1006. In other embodiments, method 1000 measures the HRV using sensors that monitor other parts of the user's body, rather than the finger and wrist. For example, the sensor may monitor the ankle, leg, arm, or torso.

Referring again to FIG. 10A, at step 1008, method 1000 may create and update a smart activity score by modifying, based on the fatigue level, the metabolic activity score. Method 800 may create the smart activity score by increasing or decreasing the metabolic activity score according to the fatigue level. The fatigue level may be represented as a numerical value. In one embodiment, the fatigue level is represented as a relative value, for example, as a current fatigue level relative to an average fatigue level for the user. Method 1000 may use this relative value to scale, increment, or decrement the metabolic activity score to create the smart activity score. The smart activity score may account not only for the movement of the user, but also for the recovery state, or fatigue level, of the user.

In some embodiments, the smart activity score is associated with a measuring period. Like the metabolic activity score, the smart activity score may be incremented or decremented throughout the measuring period according to the user's movement, including the user activity types and the user activity intensities. In one embodiment, the smart activity score is reset at the end of the measuring period. For example, the smart activity score may be reset to zero or a number other than zero. In another embodiment, the smart activity score is associated with a measuring period that begins when method 700 detects the fatigue level at step 1006.

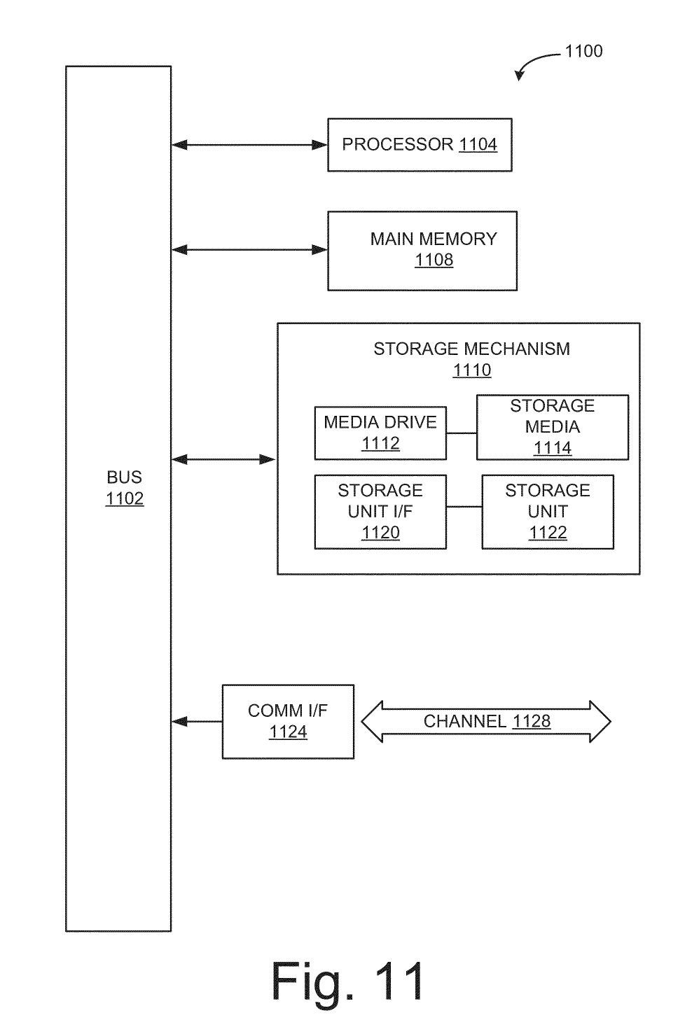

FIG. 11 illustrates an example computing module that may be used to implement various features of the systems and methods disclosed herein. In one embodiment, the computing module includes a processor and a set of computer programs residing on the processor. The set of computer programs may be stored on a non-transitory computer readable medium having computer executable program code embodied thereon. The computer executable code may be configured to monitor a movement to determine a metabolic loading associated with the movement. The computer executable code may be configured to create and update a metabolic activity score based on the metabolic loading. The computer executable code may be configured to detect a fatigue level. The computer executable code may be configured to create and update a smart activity score by modifying the activity score based on the fatigue level.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 1100. After reading this description, it will become apparent to a person skilled in the relevant art how to implement the application using other computing modules or architectures.

Referring now to FIG. 11, computing module 1100 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 1100 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1100 might include, for example, one or more processors, controllers, control modules, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing module 1100 or to communicate externally.

Computing module 1100 might also include one or more memory modules, simply referred to herein as main memory 1108. For example, preferably random access memory (RAM) or other dynamic memory, might be used for storing information and instructions to be executed by processor 1104. Main memory 1108 might also be used for storing temporary variables or other intermediate information during execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a solid state drive, a magnetic tape drive, an optical disk drive, a CD or DVD drive (R or RW), or other removable or fixed media drive might be provided. Accordingly, storage media 1114 might include, for example, a hard disk, a solid state drive, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing module 1100. Such instrumentalities might include, for example, a fixed or removable storage unit 1122 and a storage interface 1120. Examples of such storage units 1122 and storage interfaces 1120 can include a program cartridge and cartridge interface, a removable memory (for example, a flash memory or other removable memory module) and memory slot, a PCMCIA slot and card, and other fixed or removable storage units 1122 and storage interfaces 1120 that allow software and data to be transferred from the storage unit 1122 to computing module 1100.

Computing module 1100 might also include a communications interface 1124. Communications interface 1124 might be used to allow software and data to be transferred between computing module 1100 and external devices. Examples of communications interface 1124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 1100 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A method for displaying a competitive lag-lead value, comprising;
calculating a first metric of interest with a first activity monitoring device;
receiving on the first activity monitoring device a second metric of interest from a second activity monitoring device, wherein the second metric of interest is the same type of metric as the first metric of interest;
calculating a first competitive lag-lead value from the first metric of interest and a second lag-lead value from the second metric of interest;
displaying the first and second competitive lag-lead values on a competitive lag-lead display system by illuminating one or more display pixels.

2. The method of claim 1, further comprising:
illuminating a first set of display pixels on the lag-lead display in a first color, the first number corresponding to the first lag-lead value; and
illuminating a second set of display pixels on the lag-lead display in a second color, the second number corresponding to the second lag-lead value.

3. The method of claim 2, wherein the first color is red and the second color is green.

4. The method of claim 1, further comprising:
displaying the first lag-lead value on a first set of display pixels grouped on a first side of the lag-lead display system; and
displaying the second lag-lead value on a second set of display pixels grouped on a second side of the lag-lead display system.

5. The method of claim 2, further comprising:
identifying a first half of the display pixels on a first side of the lag-lead display, a second half of the display pixels on a second side of the lag-lead display, a center line between the two halves, and a pixel value for each display pixel beginning with pixel value 1 for the display pixels adjacent to the center line and incrementing outwardly in whole units;
illuminating on the first half display pixels having pixel values equal to or less than the first lag-lead value; and
illuminating on the second half display pixels having pixel values equal to and less than the second lag-lead value.

6. The method of claim 1, wherein the display pixels are oriented in a straight line.

7. The method of claim 1, wherein six display pixels are on a first side of the lag-lead display and six display pixels on a second side of the lag-lead display.

8. The method of claim 1, further comprising selectably displaying a current time of day by:
determining an hours value that corresponds the current time of day;
determining a minutes value by: determining a number of minutes that corresponds to the current time of day; calculating an intermediate result equal to the number of minutes divided by five; and rounding the intermediate result to a nearest whole number;
assigning each of twelve display pixels a unique positional value between 1 and 12 inclusive such that the positional value equals the relative orientation of the pixel on the lag-lead display beginning with 1 on a first side of the display and ending with 12 on a second side of the display;
illuminating in a first color the display pixel with the positional value corresponding to the hours value; and
illuminating in a second color the display pixel with the positional value corresponding to the minutes value.

9. The method of claim 1, wherein the first metric of interest type and the second metric of interest type are selected from the group consisting of activity score, smart activity score, HRV value, calories burned within a time period, and distance traveled within a time period.

10. A competitive lag-lead display system, comprising:
a first activity monitoring device;
a plurality of display pixels oriented on a top surface of the first activity monitoring device; and
a lag-lead module configured to: (i) calculate a first metric of interest; (ii) receive a second metric of interest from a second activity monitoring device wherein the second metric of interest is the same type of metric as the first metric of interest; (iii) calculate a first competitive lag-lead value from the first metric of interest and a second lag-lead value from the second metric of interest; and (iv) illuminate one or more display pixels corresponding to the first and second competitive lag-lead values.

11. The lag-lead display system of claim 10, wherein each display pixel illuminates in either a first color or a second color and wherein the lag-lead module causes a first set of display pixels corresponding to a first lag-lead value to illuminate in the first color, and causes a second set of display pixels corresponding to a second lag-lead value to illuminate in a second color.

12. The lag-lead display system of claim 11, wherein the first color is red and the second color is green.

13. The lag-lead display system of claim 11, wherein the first set of display pixels is grouped on a first side of the lag-lead display and the second set of display pixels is grouped on a second side of the lag-lead display.

14. The lag-lead display system of claim 11, further comprising a first half of display pixels on a first side of the lag-lead display, a second half of the display pixels on a second side of the lag-lead display, and a center line between the two halves;
wherein a pixel value corresponds to each display pixel beginning with pixel value 1 for the display pixels adjacent to the center line and incrementing outwardly in whole units; and
wherein the lag-lead module causes display pixels on the first half to illuminate if the pixel value is equal to or less than the first lag-lead value and causes display pixels on the second half to illuminate if the pixel value is equal to or less than the second lag-lead value.

15. The lag-lead display system of claim 10, wherein the display pixels are oriented in a straight line.

16. The lag-lead display system of claim 10, wherein six display pixels are on a first side of the lag-lead display and six display pixels on a second side of the lag-lead display.

17. The lag-lead display system of claim 10, further comprising a time calculation and display module configured to:
calculate an hours value that corresponds the current time of day;
calculate a minutes value by dividing the number of minutes from the current time by five and rounding to the nearest whole number;
assign each of twelve display pixels a unique positional value between 1 and 12 inclusive such that the positional value equals the relative orientation of the pixel on the lag-lead display beginning with 1 on a first side of the display and ending with 12 on a second side of the display;
cause the display pixel with the positional value corresponding to the hours value to illuminate in a first color; and
cause the display pixel with the positional value corresponding to the minutes value to illuminate in a second color.

18. The lag-lead display system of claim 10, wherein the first metric of interest type and the second metric of interest type are selected from the group consisting of activity score, smart activity score, HRV value, calories burned within a time period, and distance traveled within a time period.

19. The lag-lead display system of claim 10, wherein the lag-lead module causes the first and second competitive lag-lead values to transmit to a computing device.

20. A competitive lag-lead display system, comprising:
a first activity monitoring device;
one or more reference activity monitoring devices;
a plurality of display pixels oriented on a top surface of the first activity monitoring device; and
a lag-lead module configured to: (i) calculate a first metric of interest; (ii) receive a reference metric of interest each of the reference activity monitoring devices wherein the reference metric of interest is the same type of metric as the first metric of interest; (iii) calculate a first reference lag-lead value from the first metric of interest and a reference lag-lead value from each of the reference metrics of interest; (iv) and illuminate one or more display pixels corresponding to the first and each of the reference lag-lead values.
